(19) United States
(12) Patent Application Publication
(10) Pub. No.: US 2007/0210171 A1
(43) Pub. Date: Sep. 13, 2007

(54) PRIVACY SACK FOR PURCHASING ITEMS AND SYSTEM THEREFOR

(76) Inventor: Aaron Spitz, Laguna Beach, CA (US)

Correspondence Address: CHRISTIE, PARKER & HALE, LLP, PO BOX 7068, PASADENA, CA, 91109-7068, US

(21) Appl. No.: 11/682,996

(22) Filed: Mar. 7, 2007

Related U.S. Application Data
(60) Provisional application No. 60/780,453, filed on Mar. 7, 2006.

(51) Int. Cl. G06K 7/00; G06K 15/00

(52) U.S. Cl. 235/486; 235/383

(57) ABSTRACT

A privacy purchase sack adapted for permitting users to confidentially purchase items bearing a product identification code such as a UPC code. The privacy purchase sack includes a main body portion having a sack with a wall and at least one open end, the wall having at least one window formed therethrough; and a section of adhesive for aligning the at least one window with a UPC or other product identification code on an item to be purchased, wherein the item is placed within the walls the main body portion to conceal the identity of the item to be purchased except for the UPC or other product identification code showing through the window.

### CROSS-REFERENCE TO RELATED APPLICATION(S)

This application is based upon and claims priority on U.S. Provisional patent application No. 60/780,453 filed on Mar. 7, 2006, the contents of which are fully incorporated herein by reference.

### BACKGROUND

This invention relates to sacks and bags for carry other items, and more particularly to a sack for use purchasing in a confidential and private manner items bearing a UPC code and/or another product identification code.

### SUMMARY OF THE INVENTION

The invention is a disposable privacy purchase sack for use by consumers who are purchasing items the identity of which the purchaser would rather not reveal to onlookers, including the checker. Like the plastic sacks available in the produce or the meat sections of a grocery store, these sacks would ideally be available in the aisles where personal hygiene items are sold, or similarly in aisles where liquor, birth control items, or other such personally sensitive items are sold. Each sack will bear a transparent window in a body of opaque material that makes up the balance of the sack. The transparent window will be aligned with a UPC code for the item to be purchased so that the checker at the checkout counter, other patrons in the store and other customers in the checkout line will not be able to identify the item being purchased. Depending on the store, sacks can be offered free of charge or the user can be charged for the privacy sacks. Likewise, the sack can be purchased by the consumer for elective use if it not provided by the retailer.

As noted above, all items for purchase that the privacy purchase sack would be used for are labeled with a UPC code and/or some other product identification code. Hereinafter, however, the description will refer to UPC, with the understanding that it also encompasses other product identification codes. UPC codes are typically provided in two size formats. The privacy sack is constructed such that it is opaque except for a window, which window has a surrounding rim of adhesive. The window is sized to fully reveal the UPC code. If desired, the sacks themselves can be provided in a variety of sizes to accommodate smaller items, (e.g., a box of condoms) to larger items, (e.g., adult diapers, etc.) Likewise, in order to provide the ideal sized window, the sacks can be provided with both a smaller window and a larger window, which windows are covered up, e.g., by a perforated section of material that covers the windows. By the user selectively removing the desired window cover, the proper window size will be available to place over the UPC code on the item to be purchased. In order to main registration of the window with the UPC code, around the window there is an adhesive rim (e.g., a contact adhesive), which can be revealed by peeling away a release film. Alternatively, the window itself can be covered with contact adhesive so that the window can be stuck to the UPC code. In lieu of single sacks with two different sized windows, two different sets of sacks may be provided, each with its own size of window, or there may be a universal sack with a fixed window, which is the smaller of the two sizes, and a perforated periphery to this window, which, once fully punched out, produces the larger sized window. Again, the windows can either be surrounded with an adhesive rim that is exposed by removing a release sheet, or the window itself can be covered with contact adhesive that is exposed when a release sheet is removed.

The sack is utilized by aligning the window of the sack with the UPC code on the item to be purchased such that the UPC code is visible through the window. The adhesive surrounding (or on) the window of the sack keeps the edges of the window adherent to the item to be purchased. The item is then inverted into the bag, turning the bag inside out. The window is placed toward the inferior-most aspect of the sack and the sack is sized generously enough to allow easy inversion of the item into the sack. The sack may have a closure to close off the open end of the bag. The closure can comprise a simple flap, without or without an adhesive to close it, or any other presently available or in the future developed closures.

Once the item to be purchased is inside the sack, the sack and it enclosed item will be presented to the check out clerk without the clerk or other customers in check out line being able to identify the item. However, because the UPC code is visible, the item can still be scanned and charged easily. Furthermore, although the checker cannot see the item aside from the UPC code, he/she can easily ascertain by palpation of the sack's contents that the sack contains only the one item being purchased. Also, if desired, the display can include some description, such as “small box about 1″×2″×5″ to help the clerk confirm that the UPC for the item being scanned correlates to the item, to avoid possible fraud that might be perpetrated if a user were to attempt to apply the UPC code for different item than the item being purchased.

In one embodiment of the invention, the software of the register is modified to display “personal item” or some other text on the check out computer screen and the receipt rather than the exact item that corresponds to the UPC code to thereby maintain the identity of the item to be confidentially purchased. However, the software will continue to identify the exact item for the purposes the store's financial, inventory and other requirements.

Another aspect of the invention discloses a method and system for confidentially purchasing items without other customers or the checkout clerk from knowing the identity of the item purchased. The system uses a sack or other overlay to conceal the identity of the item to be purchased except for its UPC code. In the system, the clerk who is checking out items will need to identify for the scanning system that the item to be purchased is to remain private. In order to do this, the sack itself can bear its own UPC code or other 2-D privacy directive code. By scanning this special UPC code, the software can, if desired, add a charge for the price of the privacy sack (if applicable) and also indicate that the next UPC code to be scanned is not to appear on the checkout software or on the receipt given to the purchaser. Alternately, when a checker encounters a privacy sack, the checker can manually activate a “no-show” function on the cash register so that the next item to be scanned is not identified by its contents on the display screen(s) of the cash register or the printed receipt.

### BRIEF DESCRIPTION OF THE DRAWINGS

FIG. 1 is a diagrammatic top view of an exemplary embodiment of a privacy purchase sack of the invention.

FIG. 2 is a detail showing the window portion of the exemplary embodiment of the privacy purchase sack of FIG. 1.

FIG. 3 is a detail showing a dual size window before being enlarged from its smaller size window to its larger sized window.

FIG. 4 is a detail showing the dual size window of FIG. 3 after being enlarged.

FIG. 5 is a diagrammatic isometric view showing a window of a privacy sack of the invention being aligned with a UPC code on an item to be purchased.

FIG. 6 is a diagrammatic isometric view showing an item in the privacy sack after the privacy sack is inverted to enclose the item.

FIG. 7 is a diagrammatic perspective view showing the item in the privacy sack with its UPC code revealed through the window.

FIG. 8 is a diagrammatic top view of another exemplary embodiment of a privacy purchase sack of the invention having an elongate window.

FIG. 9 is a diagrammatic top view of yet another exemplary embodiment of a privacy purchase sack of the invention having a flat sheet with a window for overwrapping items while revealing the UPC code.

FIG. 10 is a diagrammatic top view of yet a further exemplary embodiment of a privacy purchase sack of the invention having an open window with a clear adhesive tab.

FIG. 11 is a flowchart showing an exemplary embodiment of a privacy sack purchasing system of the invention.

### DETAILED DESCRIPTION OF THE INVENTION

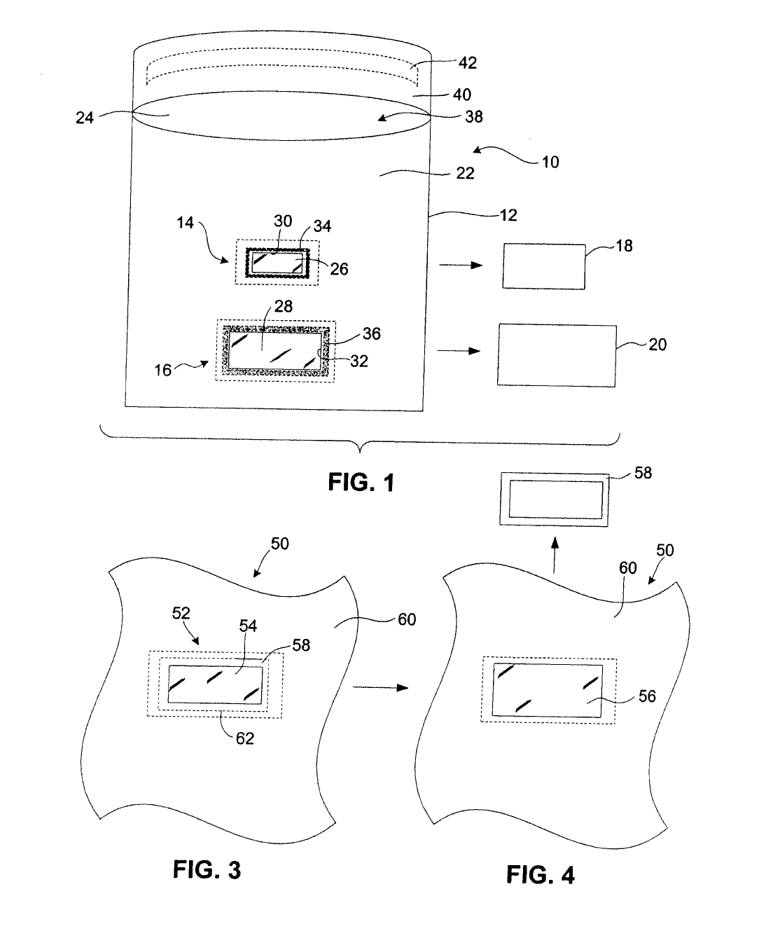

FIG. 1 is a diagrammatic top view of an exemplary privacy purchase sack 10 of the invention. It has a main bag portion 12 shown before it is inverted around the item to be purchased, and will be referred to as being in a “pre-inverted” state. In the embodiment of FIG. 1, smaller window portion 14 and larger window portion 16 are shown formed through the bag. Each of the two windows 14 and 16 will be covered with opaque window covers 18 and 20, respectively, (not shown) with the window to be exposed having its window cover 18 or 20 removed and discarded. In the pre-inverted state, a first surface 22 is shown facing outwardly and the second surface 24 is shown through an opened end 38 of the privacy sack 10 facing inwardly. Instead of providing the main bag portion 12 with two windows 14 and 16, a single window of the desired size may be provided (not shown). Each window 14, 16 has a transparent layer 26, 28 which is affixed to cover an opening 30, 32 formed in the main body portion 12. It is also possible to eliminate the transparent layer 26, 28 and instead simply use the openings 30, 32 formed in the main body portion 12 without any transparent layer. A rim of contact adhesive 34, 36 is formed around the openings 30, 32 on the first surface 22 of the main body portion 12. These rims of contact adhesive 34, 36 can be exposed by removing a release sheet (which can comprise the opaque window covers 18, 20, respectively). In lieu of a rim of contact adhesive around the openings 30, 32, the transparent layer 26, 28 can itself be covered with a transparent contact adhesive (which does not mask the UPC) to which the transparent layer 26, 28 can be attached (not shown). If desired, the main bag portion 12 can include a closure 40, such as a flap and can also include an adhesive sealing strip 42 (shown in phantom on the opposite side of the flap), which can be covered with a release film, to seal the bag 10 closed, which is described below. Also, for ease of manufacturing, it is possible to form a window or windows in the privacy sack by die cutting serrated lines through both the front and rear wall of the privacy sack, which the user can tear out the die cut rectangular window portion that is surrounded by the adhesive (not shown).

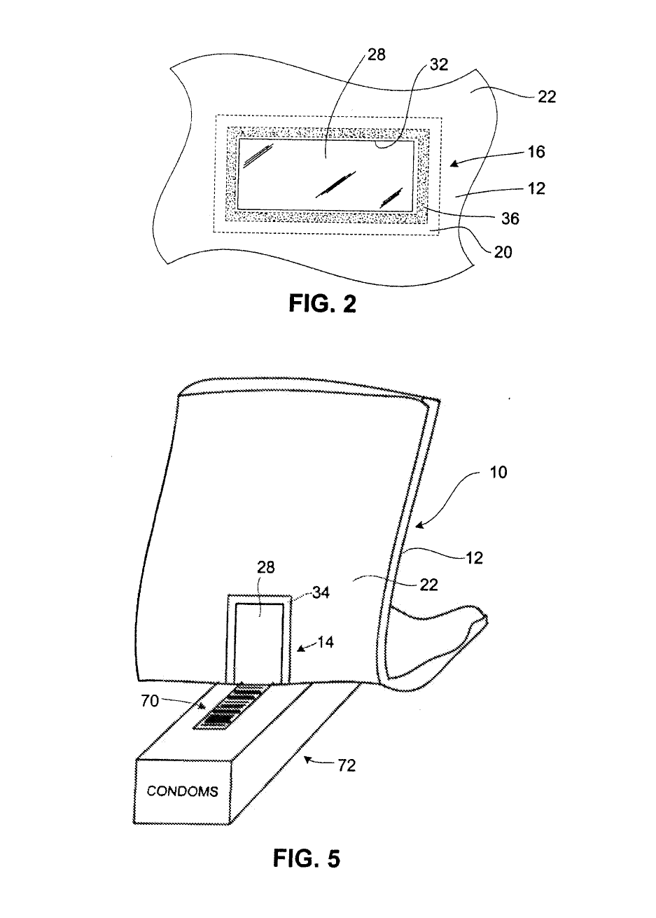

FIG. 2 is a detail showing a window portion 16 of the exemplary privacy purchase sack of FIG. 1 and its transparent layer 28 which is affixed to cover the opening 32 formed in the main body portion 12. The rim of contact adhesive 36 is shown formed around the openings 32 on a first surface 22 of the main body portion 12. The window cover 20 is shown in phantom affixed to the adhesive rim 36.

FIG. 3 is a detail showing an exemplary privacy purchase sack 50 with dual size window 52 before being enlarged from its smaller size window 54 to its larger sized 56 window, as shown in FIG. 4, by tearing off a sizing frame 58 from the wall of the main bag portion 60 along serration lines 62. The release sheet 64 is shown covering the window 54, 56.

FIG. 5 is a diagrammatic isometric view showing a window 14 of a privacy sack 10 being aligned with a UPC code 70 on an item 72 to be purchased. The adhesive rim 34 around the window 14 on the first surface 22 of the privacy sack 10 can be exposed by removing the contract sheet (not shown), and attaching it around the perimeter of the UPC code 70.

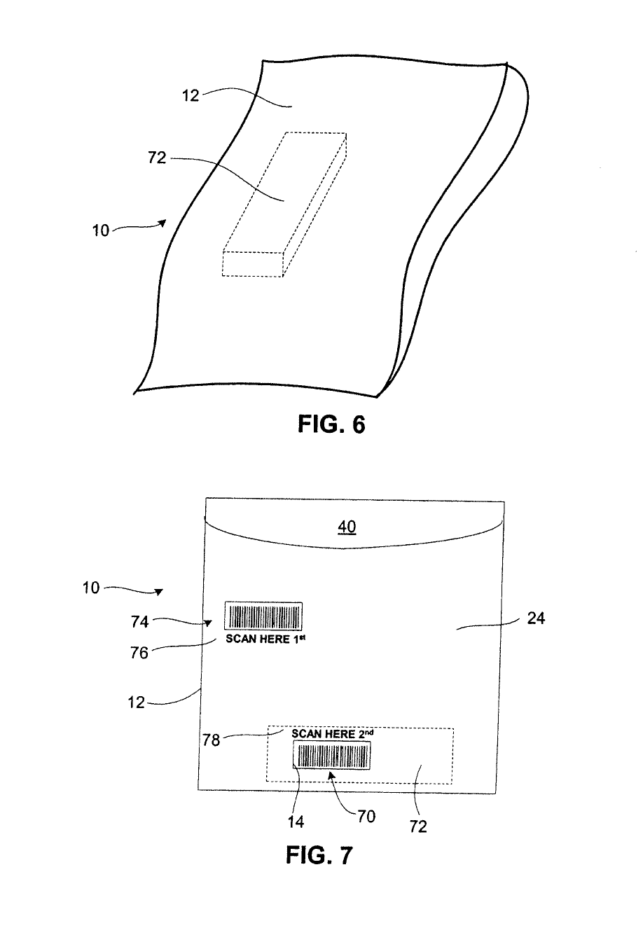

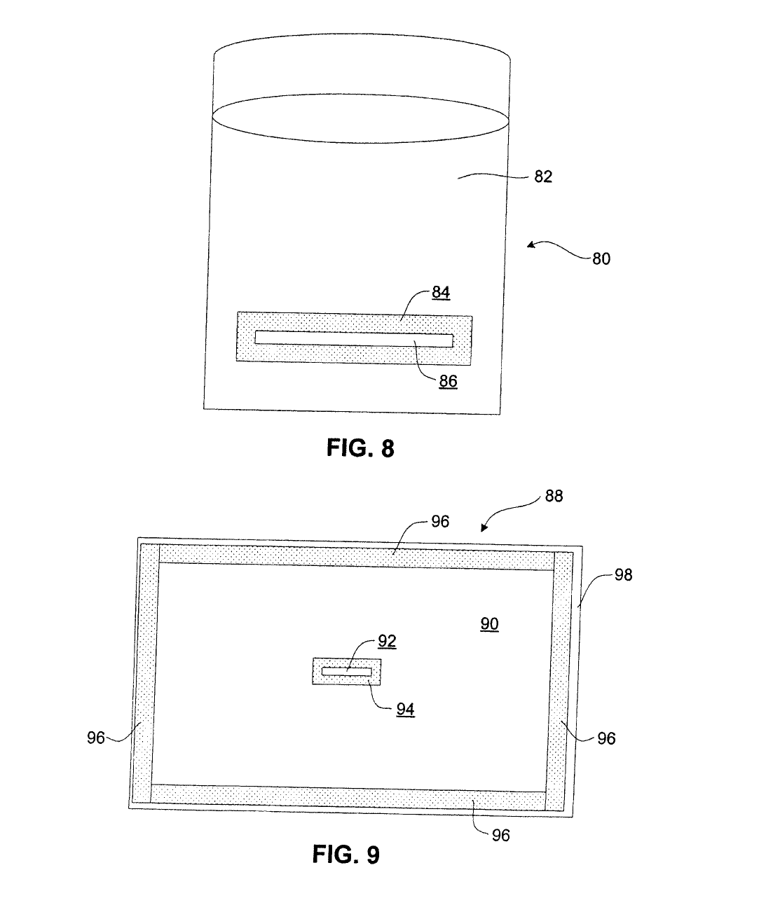

FIG. 6 is a diagrammatic isometric view showing the item 72 (in phantom) to be purchased in the privacy sack 10 after the privacy sack has been inverted to enclose the item 72, and FIG. 7 is a diagrammatic top view showing the item 72 in the privacy sack with its UPC code 70 revealed through the window 16. The privacy sack 10 itself can bear its own 2-D privacy directive code 74 on the second surface 24 and preferably some instructional text 76, e.g., “SCAN HERE 1^{st}”. The privacy directive code 74 can be a bar code itself such as a UPC code. As an alternative, the privacy directive code can be located on another surface, such as a booklet of UPC codes. By scanning this privacy directive code 74, the software can add a charge for the privacy sack (if desired) and also instruct the checkout software that the next UPC code to be scanned is the UPC code 70 for the item to be purchased 72 and is not to be displayed on the cash register or printed receipt. Adjacent to the window 30 instructional text 78, e.g., “SCAN HERE 2^{nd},” can be printed adjacent to the window 14 so that there is no confusion as to which UPC is to be scanned first. Alternately, when a checker encounters a privacy sack, the checker can manually activate a “no-show” function on the cash register so that the next item to be scanned is not identified by its contents on the display screen(s) of the cash register or the printed receipt, but, for example, display “personal item” or some other text on the check out screen and the receipt. However, the software will continue to identify the exact item for the purposes the store's financial, inventory and other requirements. In lieu of providing a sack, a flat sheet of opaque material with a window can instead be used to mask the identity of the item to be purchased. Adhesive strips can be used to close off the panel around the item to be purchased.

FIG. 8 is a diagrammatic top view of another exemplary embodiment of a privacy purchase sack 80 of the invention. In this embodiment, the sack 80 has an elongate window 86 formed in a wall 82 of the sack, which window 86 is surrounded by an adhesive rim 84. As with the other embodiments, the adhesive rim 84 is preferably a pressure sensitive adhesive and has a release sheet (not shown) that may be removed when it is time to use the privacy sack. One feature of this embodiment is that the width of the window 86 is sufficient to traverse the dimension of a UPC code of any length but has a sufficient height such that the UPC code can be scanned, but the height is not large enough to permit easy visual recognition of the bag's contents.

FIG. 9 is a diagrammatic top view of yet another exemplary embodiment of a privacy purchase overwrap material 88 of the invention. In this embodiment, rather than being in the form of a sack, the overwrap material 88 comprises a flat sheet 90 (e.g., rectangular) with a window 92 formed therein which is surrounded by an adhesive rim 94. Release film (not shown) can be removed from the adhesive 94 around the window 92 to adhere it to the item to be concealed. In order to secure the overwrap material 88 around the item to be concealed, adhesive strips 96 may be provided around at least a portion of the perimeter 98 of the sheet 88. Release film (not shown) on the adhesive strips 96 around the perimeter 98 of the sheet 90 may then be removed so that the sheet can be overwrapped around the item to be concealed. Unlike the other embodiments, this embodiment of the invention does not require inverting a sack around the item to be concealed.

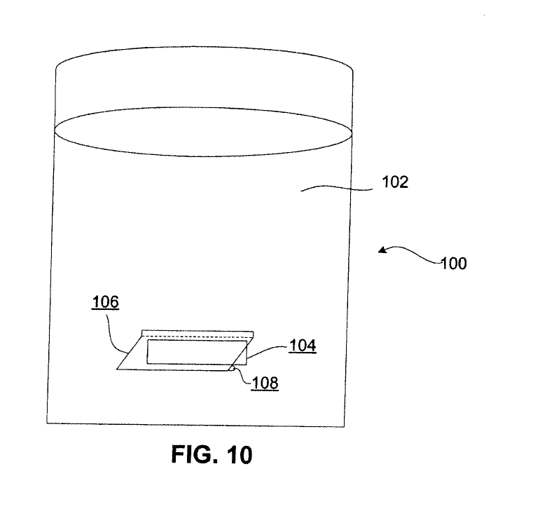

FIG. 10 is a diagrammatic top view of yet a further exemplary embodiment of a privacy purchase sack 100 of the invention having an open window 104 with a clear adhesive tab 106 that is partially attached to the wall 102 of the sack 100. A release film 108 can be removed from the clear adhesive tab 106 and discarded, so that once the window 104 is aligned with the UPC code, the clear adhesive tab 106 can be swung down and stuck to the UPC code area of the item to be concealed.

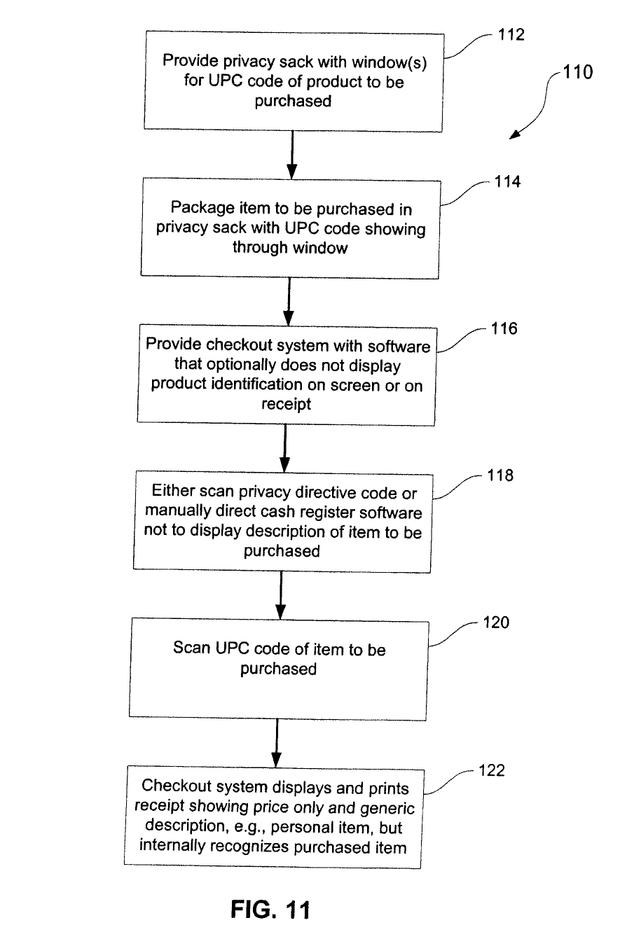

Another aspect of the invention discloses a method and system for confidentially purchasing items without other customers or the checkout clerk knowing the identity of the purchased item. FIG. 11 is a layout showing the confidential privacy sack purchasing system 110 of the invention. The first step 112 is to provide a privacy sack such as described above or some other overlay that conceals the identity of the item to be purchased, except for its UPC code. In the next step 114, the item to be purchased is placed in the privacy sack with UPC code showing through the window of the privacy sack. This is done as described above, namely by aligning the window of the privacy sack with the item to be purchased UPC code and inverting the privacy sack around the item to be purchased to fully enclose it. In the next step 116, there is provided a computerized checkout system with software that includes the option not to display the product identification on the display screens of the cash register or on receipt. The next step 118 is to invoke the “no show” feature. For example, this can be done by scanning a privacy directive code that is printed on the privacy sack itself or placed somewhere else (e.g., in a binder of UPC codes). Likewise, this can be done by manually directing the cash register software not to display the description of item to be purchased. For example, if there are no specifically programmable keys, the software of the cash register can design so that certain combinations of keystrokes will activate the no-show feature for the next items to be scanned. A following step 120 is to scan the UPC code of item to be purchased through the window in the privacy sack. In the last step 122, the checkout system displays and prints a receipt showing the price only and a generic description, e.g., “Personal Item”, but internally recognizes the purchased item. The purchaser can thus have achieved a completely confidential purchase of goods without others knowing what was purchased.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention.

What is claimed is:

1. A privacy purchase sack adapted for permitting users to confidentially purchase items bearing a product identification code, comprising:
a main body portion comprising a sack with a wall and at least one open end, the wall having at least one window formed therethrough; and
a section of adhesive for aligning the at least one window with product identification code on an item to be purchased, wherein the item is placed within the walls the main body portion to conceal the identity of the item to be purchased except for the product identification code showing through the window.

2. The privacy purchase sack of claim 1, wherein the section of adhesive is formed adjacent to the at least one window.

3. The privacy purchase sack of claim 1, wherein the at least one window comprises at least one opening formed in the wall.

4. The privacy purchase sack of claim 1, wherein the at least one opening is covered with a transparent layer of material.

5. The privacy purchase sack of claim 4, wherein the section of adhesive is transparent and is located on the at least one window.

6. The privacy purchase sack of claim 1, wherein the at least one window comprises a removable section that is adapted so a user can enlarge the size of the window by removing the removable section.

7. The privacy purchase sack of claim 1, comprising a first, smaller window and a second, larger widow that are formed in the walls of the sack, and sections of adhesive that are located adjacent to the first and second windows.

8. The privacy purchase sack of claim 1, wherein the adhesive strip comprises contact adhesive and is covered by a release film that is removed prior to the adhesive strip being applied to the item to be purchased.

9. The privacy purchase sack of claim 1, further comprising a 2-D privacy directive code printed on the walls.

10. The privacy purchase sack of claim 9, wherein the 2-D code comprises a bar code.

11. The privacy purchase sack of claim 1, wherein the privacy sack further comprises a closure.

12. The privacy purchase sack of claim 1, wherein the product identification code comprises a universal product code.

13. A privacy purchase overwrap adapted to permit users to confidentially purchase items bearing a product identification code, comprising:
a main body portion comprising a wall, the wall having at least one window formed therethrough; and
a section of adhesive for retaining the at least one window in registration with the product identification code on an item to be purchased.

14. The privacy purchase overwrap of claim 13, wherein the main body portion further comprises a closure to retain the main body portion wrapped around the item to be concealed.

15. The privacy purchase overwrap of claim 14, wherein the closure comprises pressure sensitive adhesive.

16. The privacy purchase sack of claim 13, wherein the product identification code comprises a universal product code.
